(19) United States
(12) Patent Application Publication
(10) Pub. No.: US 2024/0193247 A1
(43) Pub. Date: Jun. 13, 2024

(54) SECURE MESSAGE ACCESS TECHNIQUE

(71) Applicant: Veracity, Inc., Novato, CA (US)

(72) Inventor: Shmuel Silverman, Novato, CA (US)

(73) Assignee: Veracity, Inc., Novato, CA (US)

(21) Appl. No.: 18/533,117

(22) Filed: Dec. 7, 2023

Related U.S. Application Data
(60) Provisional application No. 63/431,021, filed on Dec. 8, 2022.

(51) Int. Cl. G06F 21/36; G06F 21/42

(52) U.S. Cl. CPC G06F 21/36; G06F 21/42

(57) ABSTRACT

An electronic device that accesses content is described. During operation, the electronic device may obtain a secure message and information specifying a second electronic device. Then, the electronic device may contact, based at least in part on the information, the second electronic device, where the contact occurs via a separate second communication channel that is different from a communication channel used to obtain the secure message and the information. Moreover, the electronic device may receive, from the second electronic device, second information, where the second information facilitates access to the content associated with the secure message. Next, the electronic device may access the content in the secure message based at least in part on the second information.

### CROSS REFERENCE TO RELATED APPLICATIONS

This application claims priority under 35 U.S.C. 119(e) to U.S. Provisional Application Ser. No. 63/431,022, entitled “MITM—Resilient Document Signing System,” by Shmuel Silverman, filed on Dec. 8, 2022, and to U.S. Provisional Application Ser. No. 63/431,021, entitled “Spoof Resistant Barcodes,” by Shmuel Silverman, filed on Dec. 8, 2022, the contents of both of which are herein incorporated by reference.

### FIELD

The described embodiments relate to techniques for accessing and/or verifying content in a secure message.

### BACKGROUND

Barcode scanning is a simple and quick way to authenticate users to websites, applications, and computers. Consequently, barcode scanning is available on a wide variety of electronic devices, such as cellular telephones, tablets and computers.

Moreover, two-factor authentication (2FA), and more generally multi-factor authentication (MFA), is a security process that cross-verifies users with two different forms of identification. For example, 2FA may include an email address and proof of ownership of a cellular telephone, such as a numerical code that is received via a separate communication channel (such as a text message).

However, these and other existing authentication techniques are typically susceptible to so-called man-in-the-middle (MITM) attacks, in which a third party intercepts authentication information and subsequently uses the authentication information for fraudulent access to electronic devices and/or computers. Alternatively, in an MITM attack, the third party may modify the communicated authentication information, thereby disrupting the authentication process. Furthermore, existing authentication techniques are usually based on the identity of a user. Consequently, existing authentication techniques often do not protect user anonymity or privacy.

### SUMMARY

In a first group of embodiments, an electronic device that verifies content is described. This electronic device may include: an interface circuit that communicates with a second electronic device; a computation device (such as a processor) that executes program instructions; and memory that stores the program instructions. During operation, the electronic device receives first secure content via a first channel. Then, the electronic device obtains second secure content. Moreover, the electronic device accesses first content in the first secure content and second content in the second secure content. Next, the electronic device compares the first content and the second content. When the first content and the second content are different, the electronic device selectively performs an action.

In some embodiments, the first secure content and/or the second secure content are hashed or encrypted.

Moreover, when the first content and the second content are the same, the electronic device may indicate approval of the second content.

Furthermore, obtaining the second secure content may include scanning an image that includes the second secure content. For example, the second secure content may be included in one or more barcodes or QR codes included in or embedded in the image. Notably, the one or more barcodes or the QR codes may be distributed throughout the image. Alternatively, the one or more barcodes or the QR codes may be located at a periphery of the image.

Additionally, the action may include: rejecting the second secure content; or correcting the second content based at least in part on the first content.

In some embodiments, the first content may include at least a subset of the second content.

Another embodiment provides an image that includes the second secure content. For example, the image may be generated by a third electronic device, which may be different from the electronic device or the second electronic device.

Another embodiment provides the second electronic device, which performs counterpart operations to at least some of the aforementioned operations.

Another embodiment provides the third electronic device.

Another embodiment provides a computer-readable storage medium for use with the electronic device, the second electronic device or the third electronic device. When executed by the electronic device, the second electronic device or the third electronic device, this computer-readable storage medium causes the electronic device, the second electronic device or the third electronic device to perform at least some of the aforementioned operations or counterpart operations.

Another embodiment provides a method, which may be performed by the electronic device, the second electronic device or the third electronic device. This method includes at least some of the aforementioned operations or counterpart operations.

In a second group of embodiments, an electronic device that accesses content is described. This electronic device may include: an interface circuit that communicates with a second electronic device; a computation device (such as a processor) that executes program instructions; and memory that stores the program instructions. During operation, the electronic device obtains a secure message and information specifying the second electronic device. Then, the electronic device contacts, based at least in part on the information, the second electronic device, where the contact occurs via a separate second communication channel that is different from a communication channel used to obtain the secure message and the information. Moreover, the electronic device receives, from the second electronic device, second information, where the second information facilitates access to the content associated with the secure message. Next, the electronic device accesses the content in the secure message based at least in part on the second information.

For example, the information may include an address associated with the second electronic device. In some embodiments, the information includes a unform resource location (URL) or a uniform resource identifier (URI).

Moreover, the second information may include or may specify a hash function or an encryption key.

Furthermore, the content may include a barcode or a QR code, and the electronic device may verify a remainder of the content using the barcode or the QR code.

Additionally, obtaining the secure message and the information may include receiving, from the second electronic device, the secure message and the information. Alternatively, obtaining the secure message and the information may include scanning an image that includes the secure message and the information.

Another embodiment provides the second electronic device, which performs counterpart operations to at least some of the aforementioned operations.

Another embodiment provides a computer-readable storage medium for use with the electronic device or the second electronic device. When executed by the electronic device or the second electronic device, this computer-readable storage medium causes the electronic device or the second electronic device to perform at least some of the aforementioned operations or counterpart operations.

Another embodiment provides a method, which may be performed by the electronic device or the second electronic device. This method includes at least some of the aforementioned operations or counterpart operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in a system in accordance with an embodiment of the present disclosure.

FIG. 2 is a flow diagram illustrating an example of a method for verifying content using an electronic device in FIG. 1 in accordance with an embodiment of the present disclosure.

FIG. 3 is a drawing illustrating an example of communication between electronic devices in FIG. 1 in accordance with an embodiment of the present disclosure.

FIG. 4 is a flow diagram illustrating an example of a method for accessing content using an electronic device in FIG. 1 in accordance with an embodiment of the present disclosure.

FIG. 5 is a drawing illustrating an example of communication between electronic devices in FIG. 1 in accordance with an embodiment of the present disclosure.

FIG. 6 is a drawing illustrating an example of a data matrix code in accordance with an embodiment of the present disclosure.

FIG. 7 is a drawing illustrating an example of a quick response (QR) code in accordance with an embodiment of the present disclosure.

FIG. 8 is a drawing illustrating an example of a QR code in accordance with an embodiment of the present disclosure.

FIG. 9 is a drawing illustrating an example of an image with QR codes in accordance with an embodiment of the present disclosure.

FIG. 10 is a drawing illustrating an example of assembling one or more QR codes in an image in accordance with an embodiment of the present disclosure.

FIG. 11 is a drawing illustrating an example of an image with QR codes in accordance with an embodiment of the present disclosure.

FIG. 12 is a drawing illustrating an example of text with QR codes in accordance with an embodiment of the present disclosure.

FIG. 13 is a drawing illustrating an example of an access technique in accordance with an embodiment of the present disclosure.

FIG. 14 is a drawing illustrating an example of an access technique in accordance with an embodiment of the present disclosure.

FIG. 15 is a drawing illustrating an example of an access technique in accordance with an embodiment of the present disclosure.

FIG. 16 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an electronic device verifies content is described. During operation, the electronic device may receive first secure content (such as encrypted or hashed content). Then, the electronic device may obtain second secure content. Moreover, the electronic device may access first content in the first secure content and second content in the second secure content. Next, the electronic device may compare the first content and the second content. When the first content and the second content are different, the electronic device may selectively perform an action.

By verifying content, these communication techniques may provide the advantages of authenticity without compromising privacy of an individual that provided secure content. Notably, the communication techniques may facilitate anonymous and secure communication. Consequently, the communication techniques may provide secure and private approach for verifying content, which may enable selective access to resources (such as a computer network) or conducting or a transaction without requiring that the individual compromise their privacy. Therefore, the communication techniques may improve the user experience, which may facilitate adoption of the communication techniques.

Moreover, in a second group of embodiments, an electronic device that accesses content is described. During operation, the electronic device may obtain a secure message and information specifying a second electronic device. Then, the electronic device may contact, based at least in part on the information, the second electronic device, where the contact occurs via a separate second communication channel that is different from a communication channel used to obtain the secure message and the information. Moreover, the electronic device may receive, from the second electronic device, second information, where the second information facilitates access to the content associated with the secure message. Next, the electronic device may access the content in the secure message based at least in part on the second information.

By accessing content, these communication techniques may provide the advantages of secure communication without compromising privacy of an individual that provided the secure message. Notably, the communication techniques may facilitate anonymous and secure communication. Consequently, the communication techniques may provide secure and private approach for accessing content, which may enable selective access to resources (such as a computer network) or conducting or a transaction without requiring that the individual compromise their privacy. Therefore, the communication techniques may improve the user experience, which may facilitate adoption of the communication techniques.

We now describe embodiments of the communication techniques. In the discussion that follows, Long Term Evolution or LTE (from the 3rd Generation Partnership Project of Sophia Antipolis, Valbonne, France) is used as an illustration of a data communication protocol that is used one or more radio nodes in a cellular-telephone network. The one or more radio nodes may facilitate communication between a computer or a server, an electronic device associated with a user (such as the individual) and/or one or more other electronic devices. Consequently, the one or more radio nodes may include an Evolved Node B (eNodeB) or eNBs. In some embodiments, the communication protocol used by the one or more radio nodes may include: a third generation or 3G communication protocol, a fourth generation or 4G communication protocol, e.g., LTE, LTE Advanced or LTE-A, a fifth generation or 5G communication protocol, or other present or future developed advanced cellular communication protocol. Therefore, in other embodiments, the one or more radio nodes may include: a Universal Mobile Telecommunications System (UMTS) NodeB and radio network controller (RNC), or a New Radio (NR) gNB or gNodeB (which communicate with a network with a cellular-telephone communication protocol that is other than LTE).

Alternatively or additionally, an Institute of Electrical and Electronics Engineers (IEEE) 802.11 standard (which is sometimes referred to as ‘Wi-Fi,’ from the Wi-Fi Alliance of Austin, Texas) is used as an illustration of a communication protocol that is used by an access point in a wireless local area network (WLAN) to facilitate the communication between the computer or the server, the electronic device and/or the one or more other electronic devices. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. However, a wide variety of communication techniques or protocols may be readily used in various embodiments. For example, an electronic device and a radio node or an access point may communicate frames or packets in accordance with a wireless communication protocol, such as: Bluetooth (from the Bluetooth Special Interest Group of Kirkland, Washington), and/or another type of wireless interface.

Moreover, a radio node or the access point may communicate with other access points, radio nodes and/or computers in a network using a wired communication protocol, such as an IEEE 802.3 standard (which is sometimes referred to as ‘Ethernet’) and/or another type of wired interface. In the discussion that follows, Ethernet is used as an illustrative example.

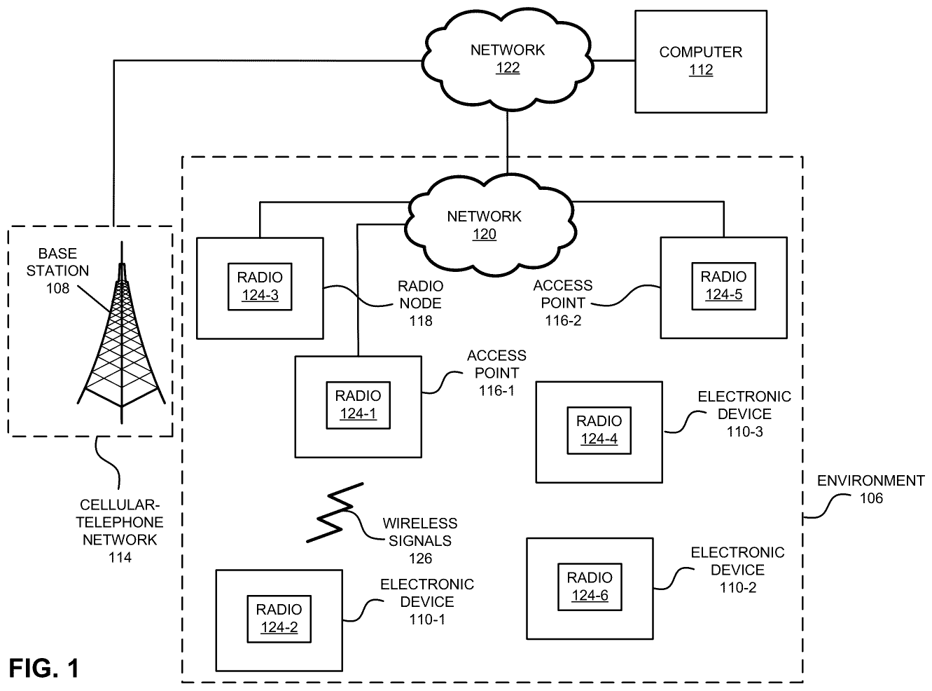

FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes in a network (such as radio node 118), which may communicate using LTE (such as a small cell or a cellular-telephone network). In the discussion that follows, an access point, a radio node or a base station are sometimes referred to generically as a ‘communication device.’ Moreover, as noted previously, one or more base stations (such as base station 108), access points 116, and/or radio node 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio node 118 may communicate with each other and/or computer 112 (which may be a cloud-based computer or server) using a wired communication protocol (such as Ethernet) via network 120 and/or 122. Note that networks 120 and 122 may be the same or different networks. For example, networks 120 and/or 122 may be an LAN, an intra-net or the Internet.

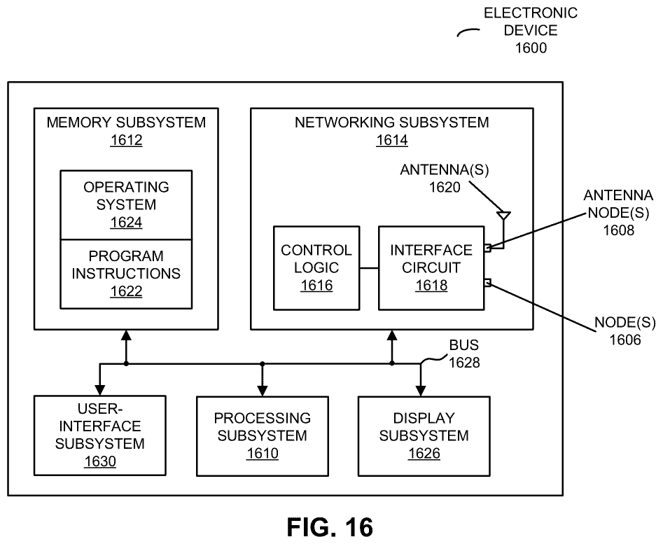

As described further below with reference to FIG. 16, electronic devices 110, computer 112, access points 116, and radio node 118 may include subsystems, such as a networking subsystem, a memory subsystem and a processor subsystem. In addition, electronic devices 110, access points 116 and radio node 118 may include radios 124 in the networking subsystems. More generally, electronic devices 110, access points 116 and radio node 118 can include (or can be included within) any electronic devices with the networking subsystems that enable electronic devices 110, access points 116 and radio node 118 to wirelessly communicate with one or more other electronic devices. This wireless communication may include transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio node 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio node 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio node 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHZ, 2.4 GHZ, 5 GHZ, 6 GHz, 60 GHz, the Citizens Broadband Radio Spectrum or CBRS (e.g., a frequency band near 3.5 GHZ), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments include more or fewer electronic devices. As another example, in another embodiment, different electronic devices are transmitting and/or receiving packets or frames.

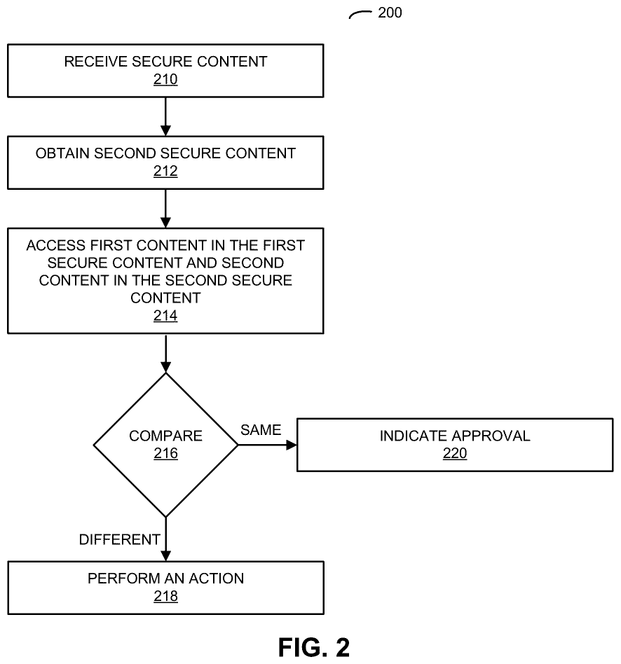

As discussed previously, it can be difficult to securely access or verify content (e.g., during a transaction between electronic devices 110-1 and 110-2) without compromising the privacy of an individual that provided the content. As described further below with reference to FIGS. 2-15, in order to address these problems, electronic devices 110-1, 110-2 and/or 110-3 may perform an embodiment of the communication techniques.

Notably, in a first group of embodiments, electronic device 110-1 may receive first secure content via a first channel. Then, electronic device 110-1 may obtain second secure content. Note that the first secure content and/or the second secure content may be hashed or encrypted.

In some embodiments, obtaining the second secure content may include scanning an image that includes the second secure content. For example, the second secure content may be included in one or more barcodes or QR codes included in or embedded in the image. Notably, the one or more barcodes or the QR codes may be distributed throughout at least a portion of the image. Alternatively or additionally, the one or more barcodes or the QR codes may be located at a periphery of the image.

Moreover, electronic device 110-1 may access first content in the first secure content and second content in the second secure content. For example, electronic device 110-1 may de-hash or decrypt the first secure content and the second secure content. Note that electronic device 110-1 may obtain information needed to access the first content and the second content when the second secure content is obtained. Next, electronic device 110-1 may compare the first content and the second content. In some embodiments, the first content may include at least a subset of the second content.

When the first content and the second content are different, electronic device 110-1 may selectively perform an action. For example, the action may include: rejecting the second secure content; or correcting the second content based at least in part on the first content. Moreover, when the first content and the second content are the same, electronic device 110-1 may indicate approval of the second content.

Furthermore, in a second group of embodiments, electronic device 110-1 may obtain a secure message and information specifying electronic device 110-2. For example, the information may include an address associated with electronic device 110-2. In some embodiments, the information includes a URL or a URI.

Note that obtaining the secure message and the information may include receiving, from electronic device 110-2, the secure message and the information. Alternatively, obtaining the secure message and the information may include electronic device 110-1 scanning (or acquiring) an image that includes the secure message and the information.

Then, electronic device 110-1 may contact, based at least in part on the information, the electronic device 110-2, where the contact occurs via a separate second communication channel that is different from a communication channel used to obtain the secure message and the information. Moreover, electronic device 110-1 may receive, from electronic device 110-2, second information, where the second information facilitates access to the content associated with the secure message. For example, the second information may include or may specify a hash function or an encryption key.

Next, electronic device 110-1 may access the content in the secure message based at least in part on the second information. Furthermore, the content may include a barcode or a QR code, and after accessing the content electronic device 110-1 may verify a remainder of the content using the barcode or the QR code.

In these ways, the communication techniques may the allow the content to be accessed or verified without compromising privacy of an individual that generated and/or provided the content. Moreover, these communication techniques may be performed seamless by electronic devices 110 in a network without requiring action by the individual. Furthermore, the information may be exchanged continuously, so that the communication techniques can provide robust and secure access or verification. Additionally, by not exchanging, storing or using information that, directly or indirectly, can be used to identify the individual, the communication techniques may significantly improve or eliminate risks to privacy and sensitive information when performing the accessing or verification.

While the preceding discussion illustrated the communication techniques using interaction among electronic devices 110, in other embodiments at least some of the described operations are performed locally and/or remotely (e.g., using computer 112). Consequently, in some embodiments, the communication techniques are implemented using a centralized and/or a distributed approach. For example, the authentication techniques may be implemented using a client-server architecture, such as using electronic device 110-1 and computer 112. Alternatively, at least some of the operations in the communication techniques may be performed by one or more of electronic devices 110.

We now describe embodiments of the method. FIG. 2 presents a flow diagram illustrating an example of a method 200 for verifying content, which may be performed by an electronic device (such as electronic device 110-1 in FIG. 1). During operation, the electronic device may receive first secure content (operation 210) via a first channel. Then, the electronic device may obtain second secure content (operation 212). In some embodiments, the first secure content and/or the second secure content are hashed or encrypted.

Moreover, the electronic device may access first content in the first secure content and second content in the second secure content (operation 214). Next, the electronic device may compare the first content and the second content (operation 216). In some embodiments, the first content may include at least a subset of the second content. When the first content and the second content are different (operation 216), the electronic device may selectively perform an action (operation 218).

In some embodiments, the electronic device may optionally perform one or more additional operations. For example, when the first content and the second content are the same (operation 216), the electronic device may selectively indicate approval of the second content (operation 220). Notably, the approval may be indicated in a user interface display on or associated with the electronic device.

Furthermore, obtaining the second secure content (operation 212) may include scanning an image that includes the second secure content. For example, the second secure content may be included in one or more barcodes or QR codes included in or embedded in the image. Notably, the one or more barcodes or the QR codes may be distributed throughout at least a portion of the image. Alternatively, the one or more barcodes or the QR codes may be located at a periphery of the image.

Additionally, selectively performing the action (operation 218) may include: rejecting the second secure content; or correcting the second content based at least in part on the first content.

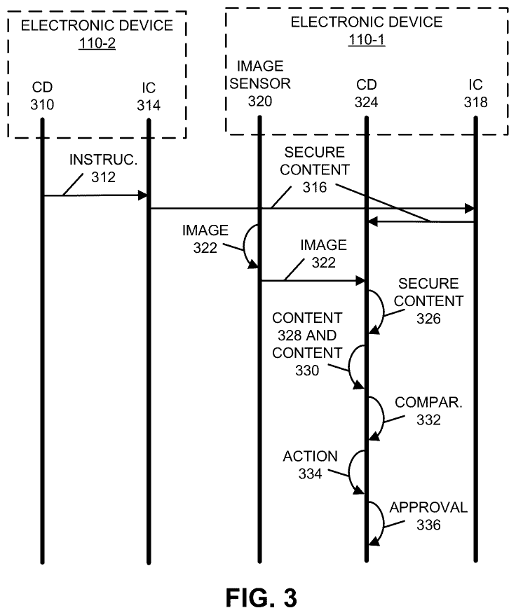

Embodiments of the communication techniques are further illustrated in FIG. 3, which presents a drawing illustrating an example of communication among electronic devices 110. In FIG. 3, a computation device (CD) 310 (such as a processor) in electronic device 110-2 may instruct 312 an interface circuit (IC) 314 in electronic device 110-2 to provide secure content 316 to electronic device 110-1. For example, secure content 316 may be provided via a first channel, such as a band of frequencies associated with a cellular-telephone data communication protocol.

After electronic device 110-1 receives secure content 316 (e.g., using interface circuit 318 in electronic device 110-1), an image sensor 320 in electronic device 110-1 may scan an image 322, which is provided to computation device 324 in electronic device 110-1. Note that image 322 may include secure content 326. For example, secure content 326 may be included in one or more barcodes or QR codes included in or embedded in image 322.

Next, computation device 324 may access content 328 in secure content 316 and may access content 330 in secure content 326. For example, information needed to access content 328 and content 330 may be included in image 322. Moreover, computation device 324 may compare 332 content 328 and content 330.

When content 328 and content 330 are different, computation device 324 may selectively perform an action 334. For example, the action may include: rejecting secure content 326; or correcting content 330 based at least in part on content 328. Moreover, when content 328 and content 330 are the same, computation device 324 may indicate approval 336 of content 330.

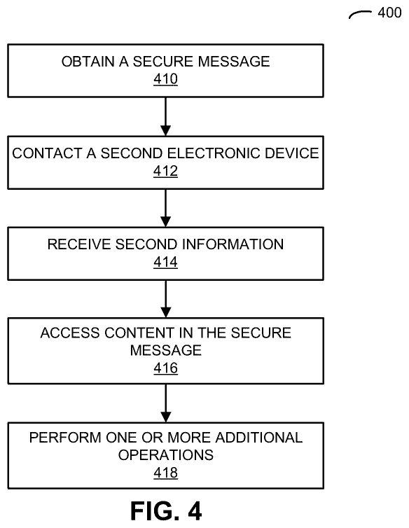

FIG. 4 presents a flow diagram illustrating an example of a method 400 for accessing content, which may be performed by an electronic device (such as electronic device 110-1 in FIG. 1). During operation, the electronic device may obtain a secure message (operation 410) and information specifying a second electronic device. For example, the information may include an address associated with the second electronic device. In some embodiments, the information includes a URL or a URI.

Then, the electronic device may contact, based at least in part on the information, the second electronic device (operation 412), where the contact occurs via a separate second communication channel that is different from a communication channel used to obtain the secure message and the information. Moreover, the electronic device may receive, from the second electronic device, second information (operation 414), where the second information facilitates access to the content associated with the secure message. For example, the second information may include or may specify a hash function or an encryption key.

Next, the electronic device may access the content in the secure message (operation 416) based at least in part on the second information.

In some embodiments, the electronic device may optionally perform one or more additional operations (operation 418). For example, the content may include a barcode or a QR code, and the electronic device may verify a remainder of the content using the barcode or the QR code.

Additionally, obtaining the secure message (operation 410) and the information may include receiving, from the second electronic device, the secure message and the information. Alternatively, obtaining the secure message (operation 410) and the information may include scanning an image that includes the secure message and the information.

In some embodiments of methods 200 (FIG. 2) and/or 400, there may be additional or fewer operations. Furthermore, the order of the operations may be changed, and/or two or more operations may be combined into a single operation.

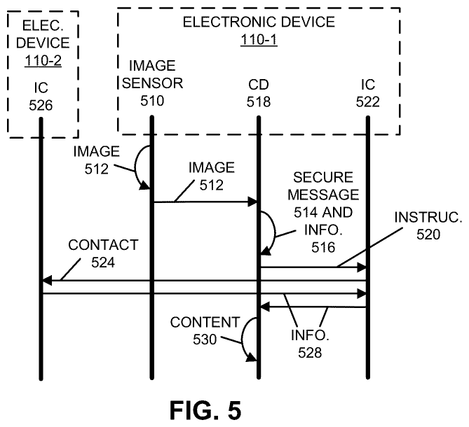

Embodiments of the communication techniques are further illustrated in FIG. 5, which presents a drawing illustrating an example of communication among electronic devices 110. In FIG. 5, an image sensor 510 in electronic device 110-1 may scan an image 512 that includes a secure message 514 and information 516 specifying electronic device 110-2 (such as a location of electronic device 110-2 in a network or an email address associated with electronic device 110-2). Image sensor 510 may provide image 512 to computation device (CD) 518 in electronic device 110-1.

Then, computation device 514 may instruct 520 an interface circuit (IC) 522 in electronic device 110-1 to contact 524 (e.g., by providing one or more frames or packets), based at least in part on information 516, electronic device 110-2. Note that contact 522 may occur via a separate second communication channel that is different from a communication channel used to obtain secure message 514 and information 516. For example, contact 522 may occur via a communication channel in a Wi-Fi or cellular-telephone band of frequencies.

In response to contact 522, an interface circuit 526 in electronic device 110-2 may provide information 528 to electronic device 110-1. This information may facilitate access to content 530 associated with secure message 514. For example, information 528 may include or may specify a hash function or an encryption key.

After receiving information 528, computation device 514 may access content 530 in secure message 514 based at least in part on information 528.

While FIGS. 3 and 5 illustrate communication between components using unidirectional or bidirectional communication with lines having single arrows or double arrows, in general the communication in a given operation in this figure may involve unidirectional or bidirectional communication.

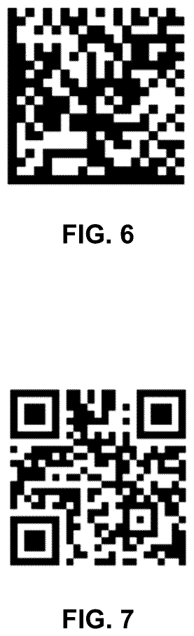

We now further describe embodiments of the communication techniques. FIG. 6 presents a drawing illustrating an example of a data matrix code. A data matrix code is a two-dimensional (2D) code that includes black and white cells that are typically arranged in a square pattern (although rectangular patterns also exist). The number of rows and columns may increase with the amount of information stored in the data matrix code, which may be limited to 2,335 alphanumeric characters. Note that the L-shape that follows its borders is its finder pattern, which may be used by scanners to recognize and read the data matrix code. The use of data matrix codes is standardized by the International Organization for Standardization/International Electrotechnical Commission (ISO/IEC) 16022 international standard.

FIG. 7 presents a drawing illustrating an example of a QR code. A QR code is a 2D code that is made of black cells arranged in a square grid on a white background. A QR code may be able to store a maximum of 4,296 alphanumeric characters. The maximum number of characters may be determined by the number of rows and columns. Its finder pattern may include three square structures in the corners, which may make it easy to recognize. QR codes are used worldwide according to the ISO/IEC 18004 international standard.

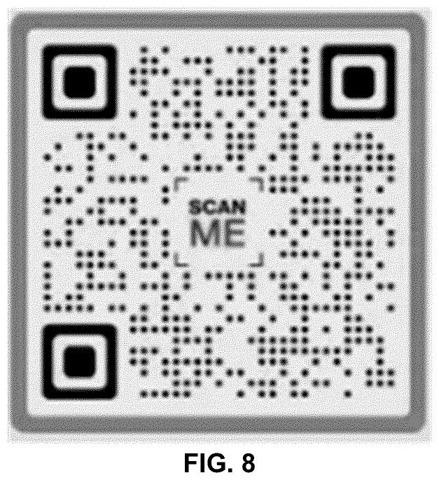

As shown in FIG. 8, which presents a drawing illustrating an example of a QR code, a QR code may allow for customization, such as by adding a small image in the center of the QR code.

Although there are many ways to represent a 2D code as described by the aforementioned standards, currently there is no standard way to represent text embedded in the code, unless it is very minimal. The initial design of the standards and what we know today as 1d, 2D or 3D barcodes, with or without colors, are all limited based on low-resolution imaging devices. These low-resolution imaging devices were envisioned at the time of these code designs.

Consequently, there is a need to be able to insert images and/or text, readable or encoded into 2D codes. For example, we would like to have support for a QR code in every row and column, and also includes images. Alternatively, we would like to have a QR code that allows for a very large central space that can include a large image or many lines of text. In fact, the code may not need to be a QR code, but may be any matrix-type code.

This disclosed communication techniques allow for multiple types of codes surrounding an image or a box in the center. An image sensor may acquire the entire image.

In the disclosed communication techniques, there may be a variety of embodiments. For example, the codes may surround an image. The image and the code combination may be captured and analyzed together. Alternatively, the codes may be randomly spread throughout an image. These codes may or may not be hidden within the image. All or only a portion of the codes may be captured (or acquired) and reassembled, read, and analyzed. Stated differently, there may be a code within an image. The code may be extracted or removed to leave behind the unwanted image.

Moreover, in some embodiments, there may be a code randomly spread (or distributed) throughout an image. This code may be pulled from the image and spread or placed along the perimeter.

Furthermore, in some embodiments, there may be one or more codes within a string of text. The text may be removed and the remaining code(s) may be analyzed and read as desired.

In another embodiment, one or more codes may be embedded in the frame and/or the pixels within the graphic itself.

Note that there are several types of known, machine-readable codes that can be used. These codes may include: linear barcodes, matrix barcodes, QR codes, watermark-based codes, etc. Additionally, these codes may be visible to human perception, invisible, watermark-activated, 1D, 2D, etc. Current imaging technologies may have resolution levels of 80 Megapixels and beyond, which may allow for the capture or acquisition of information that is hidden to the human eye.

In the communication techniques, the codes used may describe the image seen by the user or may include information unrelated to the image. Additionally, the areas that include the codes may be predefined or may not be fully defined. Once again, we can use watermarks, other colors, colors that are not visible to the human visual system, etc. These types of codes may be captured or acquired using infrared technology or other imaging devices capable of capturing watermarks, activated inks, and/or codes at different (non-visible) wavelengths.

The imaging device used may be capable of at least 80 Megapixel resolution. This imaging device may be capable of: acquiring generic images and identify and deciphering machine-readable code; capturing information that is hidden (or that is not visible) to the human eye; identifying and deciphering code using wavelengths and/or infrared technology; capturing watermarks and/or activated inks within a code; and/or separating an image from the code and its related metadata.

The imaging device may create two images: a graphic as is with the embedded code(s); and the graphic and a separate image/metadata of the identified code.

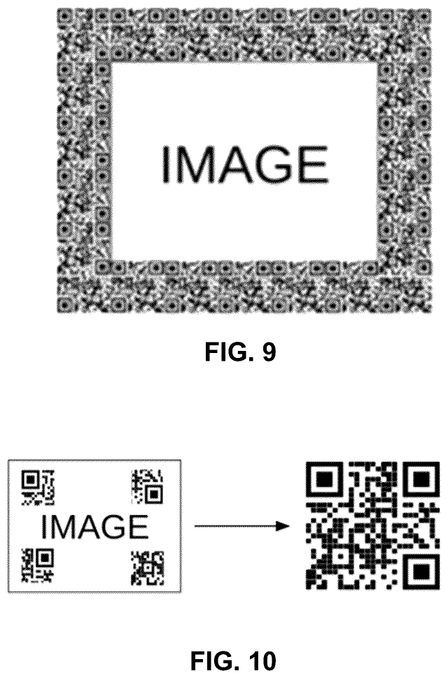

FIG. 9 presents a drawing illustrating an example of an image surrounded by QR codes. Notably, FIG. 9 depicts the case of a code surrounding an image, it can be N number of codes (where N is a non-zero integer) and any image. This image and code combination may be captured and analyzed all at once. These codes may be barcodes, QR codes, or other types of 2D or 3D codes. As described previously, the code may encode the image/graphics presented to the user.

Moreover, FIG. 10 presents a drawing illustrating an example of assembling one or more QR codes in an image. Notably, FIG. 10 depicts the case of an image with hidden codes spread or distributed within it. In this case, the codes are QR codes. All of, or a portion of, the QR codes may be acquired and reassembled into a readable code.

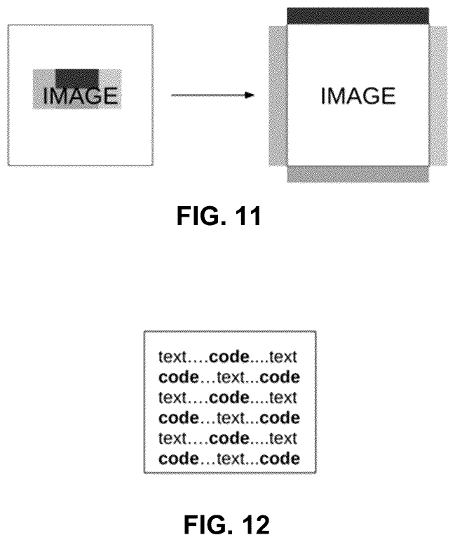

Furthermore, FIG. 11 presents a drawing illustrating an example of an image with QR codes. Notably, FIG. 11 depicts the case where a code is spread through an image and mirrored along the perimeter of the image.

Additionally, FIG. 12 presents a drawing illustrating an example of text with QR codes. Notably, FIG. 12 depicts an embodiment where code (which may be any type of code) is randomly distributed within a string of text. The code may be removed and analyzed. Alternatively, the text can be removed, and the remaining code may be captured and analyzed. In FIG. 12, the text is visible. However, in other embodiments, the code and/or text may be invisible.

In some embodiments, the codes may be embedded in the frame and/or the pixels within the graphic itself. In this case, the code may be a part of the pixels or along the edge of the frame and may be invisible to the human eye. The code may be randomly located across the image and machine-readable electronic devices may be able to identify and decipher the code.

Thus, in some embodiments, one or more codes may surround an image, and the image and code may be captured and analyzed together. Alternatively, in some embodiments, codes may be randomly or pseudo-randomly located throughout an image. These codes may or may not be hidden within the image. All or only a portion of the codes may be removed and reassembled, read, and analyzed. In some embodiments, a code may be located throughout an image and the code may be pulled from the image and spread along the perimeter.

Moreover, one or more codes may be included within a string of text, and the text may be removed and the remaining one or more codes may be analyzed. Alternatively, one or more codes may be embedded in a frame and/or the pixels within the graphic itself. In some embodiments, a code may be randomly or pseudo-randomly located or distributed in an image. Note that codes that can be visible or invisible to the human eye.

Furthermore, a given code may include information associated with or unrelated to an image that includes the given code. The areas that include the given code may or may not be predefined and may use watermarks, an arbitrary color(s(s) or may not be fully visible.

Note that the codes used in the communication techniques may be acquired using an imaging device, infrared technology, or another electronic device capable of capturing watermarks, activated inks, and/or codes associated with different wavelengths.

In some embodiments, when an attempt is made to authenticate a transaction, a problem may occur. Notably, users may log into a bank account over the Web. The bank web server may send the user a code (which may be displayed in a Web browser) to scan with their mobile application, and the mobile application may send the code back to the bank Web server. This code may be numeric or a barcode. The bank Web server may identify the information in the barcode and may authorize access. Typically, online bank applications stop at this point. Some bank applications may send a text code that is to be entered whenever there is a change in the account.

Now, let's assume a MITM. The MITM may wait for the user to either pay or move money between accounts. To the user, the MITM may present exactly what the user expects, while to the bank, the MITM may send different information and, thus, a different transaction.

The bank that wishes to authorize the transaction may send a text message with a code or may present a barcode to the user to scan. The user may scan the code or the barcode to authorize the transaction, not realizing that the transaction was changed by the MITM. The authorization code may encourage the bank Web server to execute the transaction, and no one may be the wiser.

The problem that we see is that there is no simple way for a transaction to be verified by both sides using a barcode or a code being sent to a secondary electronic device and approved by the secondary electronic device.

It does not work regardless of the number of authentication devices or the number of factors being used. Notably, multi-factor authentication does not solve this problem. The MITM is still an effective and successful attack.

In the embodiments of the communication techniques, we send an email with financial or other information to a recipient. We would like the recipient to be able to authenticate the source and to make sure that the content of the email does not change in transit by the sending server or by the receiving server.

An MITM attack can be played as follows. The sending email client may change the content once the sender hits the send button. This attack is very hard to detect today because the receiver will not know it is an attack and, when checking with the sender, e.g., via a phone call, it is often very likely that the sender will approve this transaction. For example, let's assume that the transaction is a wire transfer. The receiver may have to review all the numbers in the transaction, and the sender may have to review the numbers during a telephone call without any mistakes in order to ensure that everything is correct. However, minor changes in numbers may be very hard for a human to detect.

The receiving email client may change the email shortly after presenting the original. This is a very sophisticated attack in which the receiver of the email is checking the details with the sender over the telephone, but later the numbers and routing information may be changed without anyone noticing. It is very normal that an email is received, verified, and approved via a telephone call and then saved for later processing. The attack may change the email post-verification and before processing.

Other MITM attackers are simpler and easier to detect, thus falling under the three scenarios listed above. For example, an email sent to the receiver from another server may masquerade as coming from a known sender and asking the receiver to do something or to act on a financial transaction. This approach should fail regardless of the source, because the receiver may be able to verify the sender by calling them over the telephone or by using the disclosed communication techniques.

In this embodiment, we can demonstrate at a high level how we solve all of the above attacks for an email-based messaging system. However, note that we are not limited to the email embodiment, which is used as an example.

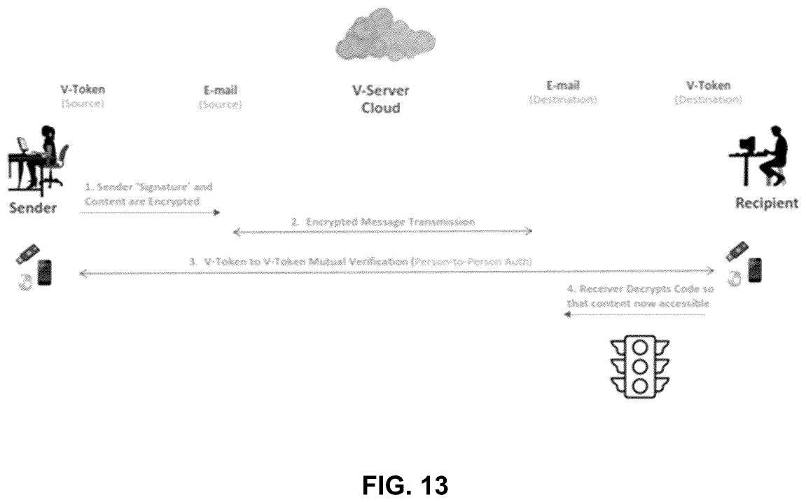

FIG. 13 presents a drawing illustrating an example of an access technique. In operation 1, a sender may author an email and sign and encrypt it. The encryption and signature may come from a separate electronic device, such as a mobile telephone or a token. The email itself and its important content may be presented to the sender inside a 2D encrypted barcode, and the sender may scan this image and remember it in their electronic device.

In operation 2, the encrypted message may be sent to the recipient. The recipient cannot open the message, but may scan the sender code with their mobile electronic device.

In operation 3, the mobile electronic device using the scanned code may connect with the mobile electronic device of the sender and may ask for a code to open the email. Because the two electronic devices recognize each other, the sender may provide the code to the recipient, as well as the scanned email content.

In operation 4, the electronic device of the recipient may provide the code to the email client to allow it to open this email.

In operation (traffic light), the recipient may scan the received content, and his/her electronic device may compare the results to the expected content received in operation 3. The electronic device may present or flash one color if the content is identical or another color when it is not.

Although this description seems to be fully secure and avoids MITM issues, this may not always be true. The use of normally encrypted barcodes or 2D codes to be scanned and sent works only for operations 2 and 3. It is important to compare the received content, which can be done only by scanning a more sophisticated barcode that also includes the email content in the open in a human-readable format. These embodiments have been described previously, such as the use of text and/or barcode information structure for 2D scanning.

What we see from the preceding embodiment is that it is possible to authenticate both the ‘who’ and the ‘what’ using a system that allows for a verifiable code scan and independent authentication of the two parties (sender and receiver) and further independent authentication of the content being sent both by the sender and the receiver.

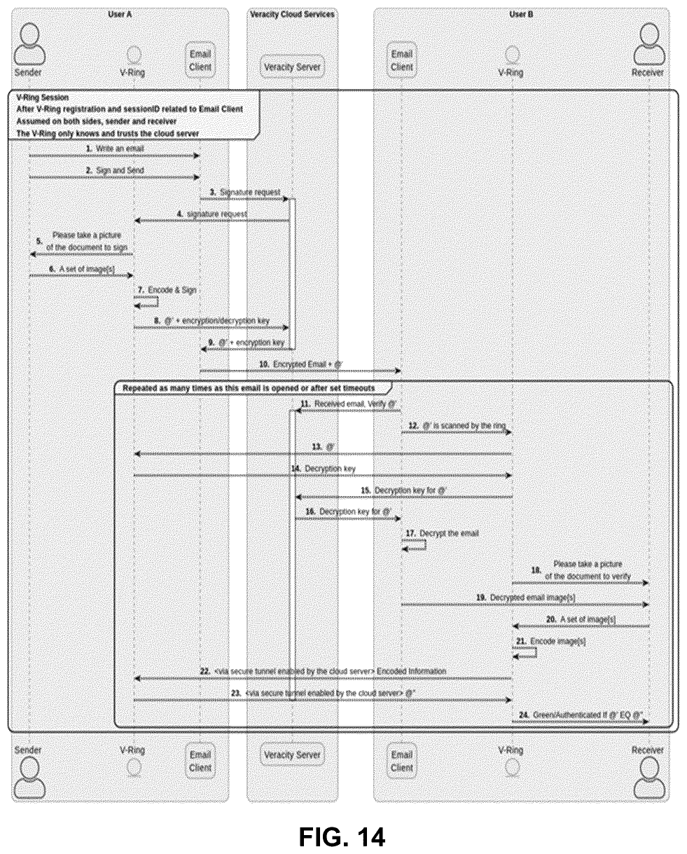

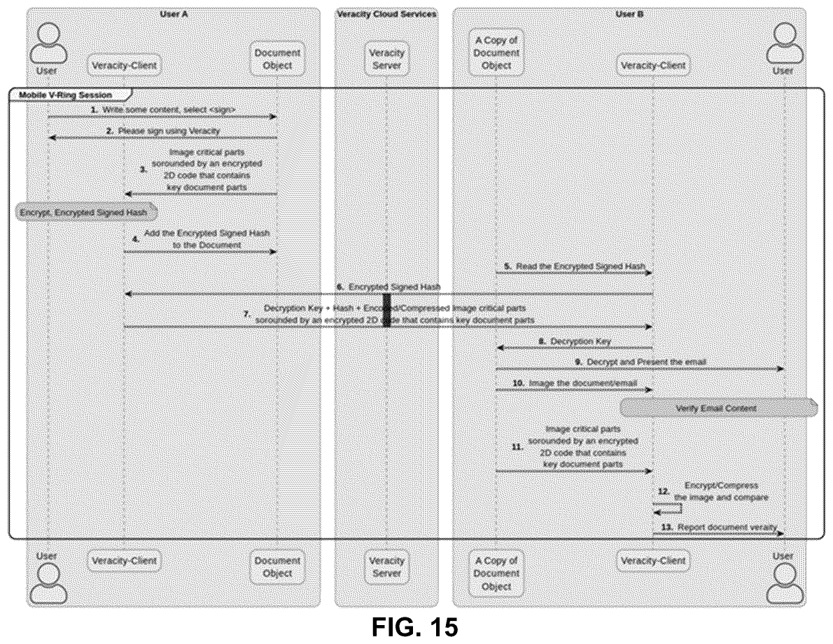

FIG. 14 presents a drawing illustrating an example of an access technique. In this embodiment, we send the image back to the sender for verification, instead of getting it from the sender into the receiver and letting the receiver verify it.

One of the innovations here is the use of both encrypted 2D code and textual information inside the code that a human can read. It significantly reduces the ability of MITM attacks and social attacks. The barcode and text integration is described in the previous embodiments.

In the next embodiment, we will see an example of how we can verify that a specific text was, in fact, written by a specific author. This can apply to a website post, a video, or any digital or physical material published by an author.

FIG. 15 presents a drawing illustrating an example of an access technique.

Note that the communication techniques may include the ability to handle signing medium objects that are text, image, document, files or another type of digital content that can be captured via an image or using a camera. This signing may be independent of the content and may verify that these medium objects did not change independent of the medium of transmission or the communication of these objects.

In some embodiments, the communication techniques may use artificial intelligence (e.g., a pretrained neural network) and/or machine learning (such as a pretrained classifier based at least in part on a supervised or an unsupervised machine-learning technique).

In some embodiments, the communication techniques may provide authentication/verification for one or more types of transactions, including: during communication (e.g., texting, phone calls, etc.); a financial transaction (such as banking or a credit-card transaction, e.g., authentication/verification of an online credit or debit-card transaction); a medical-related transaction; and/or another type of transaction (e.g., any packet or packet-based transaction). Note that the communication techniques may enable electronic signatures on any and/or all transaction, which may be signed in context by the user without their direct involvement.

In the present discussion, we use the following definitions.

A ‘transaction’ (Tr) may include the act of communicating information associated with a transaction, and can be and is not limited to a telephone call, a text message, a financial transaction, etc. It is a type of interaction between two different electronic devices or two objects.

Moreover, a ‘neural network’ may include a recurrent (RNN), a convolutional network (CNN), a deep convolutional network (DNC), or another type of neural network, and may not be limited to one kind. In the communication techniques, the NN may represent the NN can be any other type of mathematical technique (such as a supervised-learning technique, a hash function, an encoding function, etc.) that delivers the same code using a linear or a nonlinear process. A NN represents a statistical model that delivers a code or a set of numerical or alphanumerical values that represents the input.

We now describe embodiments of an electronic device, which may perform at least some of the operations in the communication techniques. FIG. 16 presents a block diagram illustrating an example of an electronic device 1600. For example, electronic device may include: one of electronic devices 110, computer 112, access point 116-1, or radio node 118. This electronic device may include processing subsystem 1610, memory subsystem 1612, and networking subsystem 1614. Processing subsystem 1610 includes one or more devices configured to perform computational operations. For example, processing subsystem 1610 can include one or more microprocessors, ASICs, microcontrollers, programmable-logic devices, GPUs and/or one or more digital signal processors (DSPs). Note that a given component in processing subsystem 1610 is sometimes referred to as a ‘computational device.’

Memory subsystem 1612 includes one or more devices for storing data and/or instructions for processing subsystem 1610 and networking subsystem 1614. For example, memory subsystem 1612 can include dynamic random access memory (DRAM), static random access memory (SRAM), and/or other types of memory. In some embodiments, instructions for processing subsystem 1610 in memory subsystem 1612 include: program instructions or sets of instructions (such as program instructions 1622 or operating system 1624), which may be executed by processing subsystem 1610. Note that the one or more computer programs or program instructions may constitute a computer-program mechanism. Moreover, instructions in the various program instructions in memory subsystem 1612 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1610.

In addition, memory subsystem 1612 can include mechanisms for controlling access to the memory. In some embodiments, memory subsystem 1612 includes a memory hierarchy that includes one or more caches coupled to a memory in electronic device 1600. In some of these embodiments, one or more of the caches is located in processing subsystem 1610.

In some embodiments, memory subsystem 1612 is coupled to one or more high-capacity mass-storage devices (not shown). For example, memory subsystem 1612 can be coupled to a magnetic or optical drive, a solid-state drive, or another type of mass-storage device. In these embodiments, memory subsystem 1612 can be used by electronic device 1600 as fast-access storage for often-used data, while the mass-storage device is used to store less frequently used data.

Networking subsystem 1614 includes one or more devices configured to couple to and communicate on a wired and/or wireless network (i.e., to perform network operations), including: control logic 1616, an interface circuit 1618 and one or more antennas 1620 (or antenna elements). While FIG. 16 includes one or more antennas 1620, in some embodiments electronic device 1600 includes one or more nodes, such as antenna nodes 1608, e.g., a metal pad or a connector, which can be coupled to the one or more antennas 1620, or nodes 1606, which can be coupled to a wired or optical connection or link. Thus, electronic device 1600 may or may not include the one or more antennas 1620. Note that the one or more nodes 1606 and/or antenna nodes 1608 may constitute input(s) to and/or output(s) from electronic device 1600. For example, networking subsystem 1614 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 1614 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1600 may use the mechanisms in networking subsystem 1614 for performing simple wireless communication between the electronic devices, e.g., transmitting advertising or beacon frames and/or scanning for advertising frames transmitted by other electronic devices as described previously.

Within electronic device 1600, processing subsystem 1610, memory subsystem 1612, and networking subsystem 1614 are coupled together using bus 1628. Bus 1628 may include an electrical, optical, and/or electro-optical connection that the subsystems can use to communicate commands and data among one another. Although only one bus 1628 is shown for clarity, different embodiments can include a different number or configuration of electrical, optical, and/or electro-optical connections among the subsystems.

In some embodiments, electronic device 1600 includes a display subsystem 1626 for displaying information on a display, which may include a display driver and the display, such as a liquid-crystal display, a multi-touch touchscreen, etc.

Moreover, electronic device 1600 may include a user-interface subsystem 1630, such as: a mouse, a keyboard, a trackpad, a stylus, a voice-recognition interface, and/or another human-machine interface. In some embodiments, user-interface subsystem 1630 may include or may interact with a touch-sensitive display in display subsystem 1626.

Electronic device 1600 can be (or can be included in) any electronic device with at least one network interface. For example, electronic device 1600 can be (or can be included in): a pen, a camera or an image sensor, a desktop computer, a laptop computer, a subnotebook/netbook, a server, a tablet computer, a smartphone, a cellular telephone, a smartwatch, a smart pen, a consumer-electronic device, a portable computing device, a wearable electronic device, an access point, a transceiver, a radio node, a router, a switch, communication equipment, a controller, test equipment, and/or another electronic device.

Although specific components are used to describe electronic device 1600, in alternative embodiments, different components and/or subsystems may be present in electronic device 1600. For example, electronic device 1600 may include one or more additional processing subsystems, memory subsystems, networking subsystems, and/or display subsystems. Additionally, one or more of the subsystems may not be present in electronic device 1600. Moreover, in some embodiments, electronic device 1600 may include one or more additional subsystems that are not shown in FIG. 16. Also, although separate subsystems are shown in FIG. 16, in some embodiments some or all of a given subsystem or component can be integrated into one or more of the other subsystems or component(s) in electronic device 1600. For example, in some embodiments program instructions 1622 are included in operating system 1624 and/or control logic 1616 is included in interface circuit 1618.

Moreover, the circuits and components in electronic device 1600 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1614 and/or electronic device 1600. The integrated circuit may include hardware and/or software mechanisms that are used for transmitting wireless signals from electronic device 1600 and receiving signals at electronic device 1600 from other electronic devices. Aside from the mechanisms herein described, radios are generally known in the art and hence are not described in detail. In general, networking subsystem 1614 and/or the integrated circuit can include any number of radios. Note that the radios in multiple-radio embodiments function in a similar way to the described single-radio embodiments.

In some embodiments, networking subsystem 1614 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used an Ethernet, a cellular-telephone communication protocol (such as LTE) and/or a Wi-Fi communication protocol as an illustrative example, in other embodiments a wide variety of communication protocols and, more generally, wireless communication techniques may be used. For example, the communication protocol in a WLAN may use OFDMA. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 1622, operating system 1624 (such as a driver for interface circuit 1618) or in firmware in interface circuit 1618. Thus, the communication techniques may be implemented at runtime of program instructions 1622. Alternatively or additionally, at least some of the operations in the communication techniques may be implemented in a physical layer, such as hardware in interface circuit 1618.

In the preceding description, we refer to ‘some embodiments.’ Note that ‘some embodiments’ describes a subset of all of the possible embodiments, but does not always specify the same subset of embodiments. Moreover, note that the numerical values provided are intended as illustrations of the communication techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a second electronic device;
a computation device coupled to the interface circuit; and
memory, coupled to the computation device, configured to store program instructions, wherein, when executed by the computation device, the program instructions cause the electronic device to perform operations comprising:
obtaining a secure message and information specifying the second electronic device;
contacting, based at least in part on the information, the second electronic device, wherein the contact occurs via a separate second communication channel that is different from a communication channel used to obtain the secure message and the information;
receiving, from the second electronic device, second information, wherein the second information facilitates access to content associated with the secure message; and
accessing the content in the secure message based at least in part on the second information.

2. The electronic device of claim 1, wherein the information comprises an address associated with the second electronic device.

3. The electronic device of claim 1, wherein the information comprises a unform resource location (URL) or a uniform resource identifier (URI).

4. The electronic device of claim 1, wherein the information the second information comprises or specifies a hash function or an encryption key.

5. The electronic device of claim 1, wherein the content comprises a barcode or a quick response (QR) code, and the operations comprise verifying a remainder of the content using the barcode or the QR code.

6. The electronic device of claim 1, wherein obtaining the secure message and the information comprises receiving, from the second electronic device, the secure message and the information.

7. The electronic device of claim 1, wherein obtaining the secure message and the information comprises scanning an image that comprises the secure message and the information.

8. A non-transitory computer-readable storage medium for use in conjunction with an electronic device, the computer-readable storage medium configured to store program instructions that, when executed by the electronic device, causes the electronic device to perform operations comprising:
obtaining a secure message and information specifying a second electronic device;
contacting, based at least in part on the information, the second electronic device, wherein the contact occurs via a separate second communication channel that is different from a communication channel used to obtain the secure message and the information;
receiving, from the second electronic device, second information, wherein the second information facilitates access to content associated with the secure message; and
accessing the content in the secure message based at least in part on the second information.

9. The non-transitory computer-readable storage medium of claim 8, wherein the information comprises an address associated with the second electronic device.

10. The non-transitory computer-readable storage medium of claim 8, wherein the information comprises a unform resource location (URL) or a uniform resource identifier (URI).

11. The non-transitory computer-readable storage medium of claim 8, wherein the information the second information comprises or specifies a hash function or an encryption key.

12. The non-transitory computer-readable storage medium of claim 8, wherein the content comprises a barcode or a quick response (QR) code, and the operations comprise verifying a remainder of the content using the barcode or the QR code.

13. The non-transitory computer-readable storage medium of claim 8, wherein obtaining the secure message and the information comprises: receiving, from the second electronic device, the secure message and the information; or scanning an image that comprises the secure message and the information.

14. A method for accessing content, comprising:
by an electronic device:
obtaining a secure message and information specifying a second electronic device;
contacting, based at least in part on the information, the second electronic device, wherein the contact occurs via a separate second communication channel that is different from a communication channel used to obtain the secure message and the information;
receiving, from the second electronic device, second information, wherein the second information facilitates access to the content associated with the secure message; and
accessing the content in the secure message based at least in part on the second information.

15. The method of claim 14, wherein the information comprises an address associated with the second electronic device.

16. The method of claim 14, wherein the information comprises a unform resource location (URL) or a uniform resource identifier (URI).

17. The method of claim 14, wherein the information the second information comprises or specifies a hash function or an encryption key.

18. The method of claim 14, wherein the content comprises a barcode or a quick response (QR) code, and the operations comprise verifying a remainder of the content using the barcode or the QR code.

19. The method of claim 14, wherein obtaining the secure message and the information comprises receiving, from the second electronic device, the secure message and the information.

20. The method of claim 14, wherein obtaining the secure message and the information comprises scanning an image that comprises the secure message and the information.
